(19) United States
(12) Patent Application Publication
(10) Pub. No.: US 2020/0234570 A1
(43) Pub. Date: Jul. 23, 2020

(54) COMPUTER PROGRAM, ESTIMATION DEVICE AND ESTIMATION METHOD FOR VEHICLE SPEED, AND ESTIMATION DEVICE AND ESTIMATION METHOD FOR TRAFFIC CONGESTION TENDENCY

(71) Applicant: SUMITOMO ELECTRIC INDUSTRIES, LTD., Osaka-shi, Osaka (JP)

(72) Inventors: Shigeki NISHIMURA, Osaka-shi, Osaka (JP); Kentarou TAKAKI, Osaka-shi, Osaka (JP); Shoichi TANADA, Osaka-shi, Osaka (JP)

(73) Assignee: SUMITOMO ELECTRIC INDUSTRIES, LTD., Osaka-shi, Osaka (JP)

(21) Appl. No.: 16/486,850

(22) PCT Filed: Sep. 28, 2017
(86) PCT No.: PCT/JP2017/035265

§ 371 Date: Aug. 19, 2019

(30) Foreign Application Priority Data
Mar. 15, 2017 (JP) 2017-049648

(51) Int. Cl. G08G 1/01; B60W 30/14; B60W 40/105; G08G 1/0967

(52) U.S. Cl. CPC G08G 1/0112; B60W 30/146; G08G 1/096775; G08G 1/0133; B60W 40/105

(57) ABSTRACT

A computer program according to an aspect of the present disclosure is a computer program for causing a computer to function as a vehicle speed estimating device. The program causes the computer to function as a data processing unit executing: an extraction process of extracting a speed transition section which includes a plurality of target points and in which a statistical speed gradually decreases from a speed not lower than a high-speed threshold to a speed not higher than a low-speed threshold; a calculation process of calculating a propagation speed of traffic congestion on the basis of a first speed sequence having, as elements, statistical speeds at the plurality of target points included in the speed transition section; and an estimation process of estimating a vehicle speed in a predetermined section including the speed transition section, on the basis of the propagation speed.

### TECHNICAL FIELD

The present invention relates to a computer program, a device and a method for estimating a vehicle speed, and a device and a method for estimating traffic congestion tendency.

This application claims priority on Japanese Patent Application No. 2017-049648 filed on Mar. 15, 2017, the entire contents of which are incorporated herein by reference.

### BACKGROUND ART

An attempt to precisely calculate traffic information such as a link travel time by effectively utilizing probe information has already been well known (refer to Patent Literature 1).

### CITATION LIST

### Patent Literature

PATENT LITERATURE 1: Japanese Laid-Open Patent Publication No. 2007-241987

### SUMMARY OF INVENTION

(1) A computer program according to one aspect of the present disclosure is a computer program for causing a computer to function as a vehicle speed estimating device. The program causes the computer to function as a data processing unit executing: an extraction process of extracting a speed transition section which includes a plurality of target points and in which a statistical speed gradually decreases from a speed not lower than a high-speed threshold to a speed not higher than a low-speed threshold; a calculation process of calculating a propagation speed of traffic congestion on the basis of a first speed sequence having, as elements, statistical speeds at the plurality of target points included in the speed transition section; and an estimation process of estimating a vehicle speed in a predetermined section including the speed transition section, on the basis of the propagation speed.

(6) A device according to the aspect of the present disclosure is a device for estimating a vehicle speed. The device includes: a speed database in which statistical speeds at a plurality of target points are stored; and a data processing unit configured to estimate the vehicle speed by using the stored statistical speeds. The data processing unit executes: an extraction process of extracting a speed transition section which includes a plurality of target points and in which a statistical speed gradually decreases from a speed not lower than a high-speed threshold to a speed not higher than a low-speed threshold; a calculation process of calculating a propagation speed of traffic congestion on the basis of a first speed sequence having, as elements, statistical speeds at the plurality of target points included in the speed transition section; and an estimation process of estimating a vehicle speed in a predetermined section including the speed transition section, on the basis of the propagation speed.

(7) A method according to the aspect of the present disclosure is a method for estimating a vehicle speed. The method includes the steps of: extracting a speed transition section which includes a plurality of target points and in which a statistical speed gradually decreases from a speed not lower than a high-speed threshold to a speed not higher than a low-speed threshold; calculating a propagation speed of traffic congestion on the basis of a first speed sequence having, as elements, statistical speeds at the plurality of target points included in the speed transition section; and estimating a vehicle speed in a predetermined section including the speed transition section, on the basis of the propagation speed.

(8) A computer program according to another aspect of the present disclosure is a computer program for causing a computer to function as a traffic congestion tendency estimating device. The program causes the computer to function as a data processing unit executing: an extraction process of extracting a speed transition section which includes a plurality of target points and in which a statistical speed gradually decreases from a speed not lower than a high-speed threshold to a speed not higher than a low-speed threshold; a calculation process of calculating a movement direction, with a lapse of time, of a first speed sequence having, as elements, statistical speeds at the plurality of target points included in the speed transition section; and an estimation process of estimating, based on the movement direction, whether traffic congestion tends to extend or tends to diminish in a predetermined section including the speed transition section.

(9) A device according to the other aspect of the present disclosure is a device for estimating traffic congestion tendency. The device includes: a speed database in which statistical speeds at a plurality of target points are stored; and a data processing unit configured to estimate the vehicle speed by using the stored statistical speeds. The data processing unit executes: an extraction process of extracting a speed transition section which includes a plurality of target points and in which a statistical speed gradually decreases from a speed not lower than a high-speed threshold to a speed not higher than a low-speed threshold; a calculation process of calculating a movement direction, with a lapse of time, of a first speed sequence having, as elements, statistical speeds at the plurality of target points included in the speed transition section; and an estimation process of estimating, based on the movement direction, whether traffic congestion tends to extend or tends to diminish in a predetermined section including the speed transition section.

(10) A method according to the other aspect of the present disclosure is a method for estimating traffic congestion tendency. The method includes the steps of: extracting a speed transition section which includes a plurality of target points and in which a statistical speed gradually decreases from a speed not lower than a high-speed threshold to a speed not higher than a low-speed threshold; calculating a movement direction, with a lapse of time, of a first speed sequence having, as elements, statistical speeds at the plurality of target points included in the speed transition section; and estimating, based on the movement direction, whether traffic congestion tends to extend or tends to diminish in a predetermined section including the speed transition section.

### BRIEF DESCRIPTION OF DRAWINGS

FIG. 1 is a schematic configuration diagram showing a traffic information processing system according to an embodiment of the present disclosure.

FIG. 2 is a block diagram showing a schematic configuration of a center apparatus.

FIG. 3 is an explanatory diagram showing a management table of statistical speed data.

FIG. 4 is an explanatory diagram showing an example of a speed transition section extracting process.

FIG. 5 is an explanatory diagram showing an example of a process of searching for a similar speed sequence corresponding to a present speed sequence.

FIG. 6 is an explanatory diagram showing an example of a congestion propagation speed calculating process.

FIG. 7 is an explanatory diagram showing an example of a vehicle speed estimating process.

FIG. 8 is an explanatory diagram showing a modification of the vehicle speed estimating process.

FIG. 9 is a graph showing an example of a simulation result in a case where traffic congestion is extending.

FIG. 10 is a graph showing an example of a simulation result in a case where traffic congestion is diminishing.

### DESCRIPTION OF EMBODIMENTS

### Problem to be Solved by the Present Disclosure

As a method of utilizing probe information other than that described in Patent Literature 1, there is a method in which, based on probe information acquired from a plurality of probe vehicles that have passed a predetermined target point during the most recent observation time period (e.g., 15 minutes), an average speed at the target point is calculated, and the calculated average speed at the target point is provided to a user as a vehicle speed at the present time.

However, in a case where a time difference between the present time and the time when the probe information used for calculation of the average speed has been acquired is great (e.g., 5 minutes or more), if extension or diminishment of traffic congestion or the like has occurred during a time period from the probe information acquisition time to the present time, the average speed to be provided to the user may significantly diverge from the actual vehicle speed, which may cause a large error to be included in the vehicle speed provided to the user or may cause the user to be incapable of knowing variation in traffic congestion that is actually occurring.

In view of the conventional problems, an object of the present disclosure is to accurately estimate, from a statistical speed, at least one of an actual vehicle speed and a traffic congestion tendency.

### Effect of the Present Disclosure

According to the present disclosure, at least one of an accurate vehicle speed and a traffic congestion tendency can be estimated from a statistical speed.

### Outline of Embodiment of Present Disclosure

Hereinafter, the outline of an embodiment of the present disclosure is listed and described.

(1) A computer program according to the present embodiment is a computer program for causing a computer to function as a vehicle speed estimating device. The program causes the computer to function as a data processing unit executing: an extraction process of extracting a speed transition section which includes a plurality of target points and in which a statistical speed gradually decreases from a speed not lower than a high-speed threshold to a speed not higher than a low-speed threshold; a calculation process of calculating a propagation speed of traffic congestion on the basis of a first speed sequence having, as elements, statistical speeds at the plurality of target points included in the speed transition section; and an estimation process of estimating a vehicle speed in a predetermined section including the speed transition section, on the basis of the propagation speed.

According to the computer program of the present embodiment, the data processing unit calculates the propagation speed of traffic congestion on the basis of the first speed sequence having, as elements, the statistical speeds at the plurality of target points included in the speed transition section, and estimates the vehicle speed in the predetermined section including the speed transition section, on the basis of the propagation speed.

Therefore, even if extension or diminishment of traffic congestion has occurred after the acquisition time of original data (e.g., probe information) to be used for calculation of the statistical speed, it is possible to accurately estimate an actual vehicle speed from the statistical speed.

(2) In the computer program according to the present embodiment, preferably, the data processing unit executes a searching process of searching for a second speed sequence that is similar to the first speed sequence in variation pattern of the elements, and that has, as elements, statistical speeds older than the statistical speeds of the first speed sequence, and calculates the propagation speed on the basis of a distance and a time difference between the first speed sequence and the second speed sequence.

According to the computer program of the present embodiment, since the data processing unit calculates the propagation speed of traffic congestion on the basis of the distance and the time difference between the first speed sequence and the second speed sequence, it is possible to accurately calculate the propagation speed.

Thus, the vehicle speed estimating process can be executed based on an accurate propagation speed, thereby improving the vehicle speed estimation accuracy.

(3) In the computer program according to the present embodiment, the data processing unit preferably searches for a plurality of second speed sequences that are different in oldness, calculates a plurality of propagation speeds by using the plurality of second speed sequences, and uses, for the estimation process, a statistic of the plurality of calculated propagation speeds.

According to the computer program of the present embodiment, since the data processing unit calculates the plurality of propagation speeds by using the plurality of second speed sequences and uses, for the estimation process, the statistic of the plurality of calculated propagation speeds, it is possible to execute the vehicle speed estimating process based on a more accurate propagation speed. Thus, the vehicle speed estimation accuracy can be further improved.

(4) In the present embodiment, preferably, the data processing unit calculates the statistical speeds on the basis of probe information of one or a plurality of probe vehicles, and corrects the statistical speeds at the target points included in the predetermined section, on the basis of the propagation speed and an elapsed time from a time point when the probe vehicle has passed a predetermined target point in the speed transition section, thereby estimating the vehicle speed at the target point.

According to the computer program of the present embodiment, since the data processing unit corrects the statistical speeds at the target points included in the predetermined section, on the basis of the elapsed time and the propagation speed, to estimate the vehicle speed, it is possible to accurately estimate the vehicle speed.

(5) In the computer program according to the present embodiment, the data processing unit may determine a position of a traffic congestion tail in the predetermined section, on the basis of the vehicle speed in the predetermined section.

According to the computer program of the present embodiment, since the data processing unit determines the position of the traffic congestion tail in the predetermined section, on the basis of the vehicle speed in the predetermined section obtained through the estimation process of the present embodiment, it is possible to obtain the position of the traffic congestion tail more accurately than in a case where, for example, the position of the traffic congestion tail is determined based on the statistical speed.

(6) An estimation device according to the present embodiment is provided with the data processing unit that executes the computer program according to any one of the above (1) to (5).

Therefore, the estimation device of the present embodiment exhibits the same operation and effect as those of the computer program according to any one of the above (1) to (5).

(7) An estimation method according to the present embodiment is achieved when the data processing unit executes the computer program according to any one of the above (1) to (5).

Therefore, the estimation method of the present embodiment exhibits the same operation and effect as those of the computer program according to any one of the above (1) to (5).

(8) Another computer program according to the present embodiment is a computer program for causing a computer to function as a traffic congestion tendency estimating device. The program causes the computer to function as a data processing unit executing: an extraction process of extracting a speed transition section which includes a plurality of target points and in which a statistical speed gradually decreases from a speed not lower than a high-speed threshold to a speed not higher than a low-speed threshold; a calculation process of calculating a movement direction, with a lapse of time, of a first speed sequence having, as elements, statistical speeds at the plurality of target points included in the speed transition section; and an estimation process of estimating, based on the movement direction, whether traffic congestion tends to extend or tends to diminish in a predetermined section including the speed transition section.

According to the other computer program of the present embodiment, the data processing unit calculates the movement direction, with a lapse of time, of the first speed sequence having, as elements, the statistical speeds at the plurality of target points included in the speed transition section, and estimates, based on the movement direction, whether traffic congestion tends to extend or tends to diminish in the predetermined section including the speed transition section.

Therefore, even if extension or diminishment of traffic congestion has occurred after the acquisition time of original data (e.g., probe information) to be used for calculation of the statistical speed, it is possible to accurately estimate an actual traffic congestion tendency from the statistical speed.

(9) Another estimation device according to the present embodiment is provided with the data processing unit that executes the computer program according to the above (8).

Therefore, the estimation device of the present embodiment exhibits the same operation and effect as those of the computer program according to the above (8).

(10) Another estimation method according to the present embodiment is achieved when the data processing unit executes the computer program according to the above (8).

Therefore, the estimation method of the present embodiment exhibits the same operation and effect as those of the computer program according to the above (8).

### Details of Embodiment of the Present Disclosure

Hereinafter, an embodiment of the present disclosure will be described in detail with reference to the drawings. At least some parts of the embodiment described below may be combined together as desired.

### Definition of Terms

In advance of describing the present embodiment in detail, terms used in this specification are defined as follows.

The term “vehicle” refers to a general vehicle traveling on a road, and includes vehicles based on the Road Traffic Law, for example. The vehicles based on the Road Traffic Law include automobiles, motorized bicycles, light vehicles, and trolley buses. In this embodiment, a reference to a “vehicle” includes both a probe vehicle having an on-vehicle device capable of transmitting probe information, and an ordinary vehicle having no such an on-vehicle device.

The term “vehicle detector” refers to a roadside detector that detects presence of a vehicle traveling on a road. Examples of the vehicle detector include: an ultrasonic vehicle detector that detects a vehicle traveling directly below the detector by using ultrasonic waves; a thermal vehicle detector that detects passage of a vehicle from a temperature change that occurs when the vehicle passes; a loop coil that is embedded in a road and detects a vehicle by an inductance change; and an image type vehicle detector that photographs an image of a predetermined road section.

The term “detection signal” refers to a pulse signal that is outputted when a vehicle detector, installed at a predetermined position on a road, has detected one vehicle. Therefore, when a plurality of vehicles have passed the vehicle detector, detection signals corresponding to the respective vehicles are outputted in time series.

The term “probe information” refers to various types of information, relating to a probe vehicle traveling on a road, which are acquired from an on-vehicle device of the probe vehicle. The probe information is also referred to as probe data or floating car data. The probe information includes data of vehicle ID, vehicle position, vehicle speed, vehicle heading, generation times thereof, etc.

Since the vehicle speed can be calculated from the vehicle position and the time, the probe information only needs to include at least the vehicle position measured every predetermined period (e.g., 1 second) and the corresponding time. Alternatively, a vehicle speed measured in the vehicle may be included in the probe information.

The term “road section” refers to a section from an arbitrary point on a road to another arbitrary point on the road.

The term “target section” refers to a road section to be subjected to calculation of a statistical speed of vehicles, among road sections included in an area under management of a center apparatus 5. A target section may include one or a plurality of links or may be a partial section included in one link.

The term “node” refers to data of node points such as intersections, which are components of a road network of a digital road map.

The term “link” refers to segment data connecting between nodes, which are components of the road network of the digital road map. When viewed from an intersection, a link in a direction that flows in toward the intersection is referred to as an “inflow link”, and a link in a direction that flows out from the intersection is referred to as an “outflow link”.

### [Traffic Information Processing System]

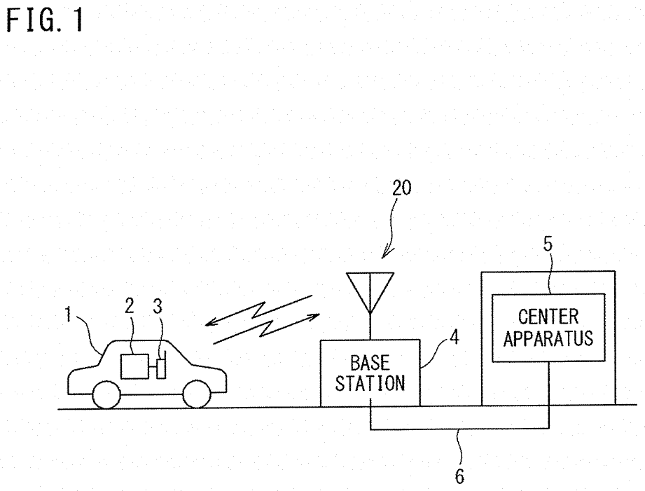

FIG. 1 is a schematic configuration diagram showing a traffic information processing system 20 according to an embodiment of the present disclosure.

In the traffic information processing system 20 according to the present embodiment, a center apparatus 5 collects, from each of a plurality of probe vehicles 1, probe information including at least data of vehicle position and passage time at the position, and the collected probe information is subjected to data processing to perform a service of providing traffic information such as a travel time, a traffic congestion state, and an optimum route.

As shown in FIG. 1, the traffic information processing system 20 includes an on-vehicle device 2 and a communication device 3 installed in a probe vehicle 1, a base station 4, and a center apparatus 5.

The on-vehicle device 2 and the base station 4 are able to perform wireless communication with each other. The base station 4 and the center apparatus 5 are able to perform wired-communication via a predetermined communication line 6. However, communication between the base station 4 and the center apparatus 5 may be wireless communication.

The on-vehicle device 2 includes a vehicle speed sensor, a heading sensor, a GPS receiver, a memory, a timer, etc. The on-vehicle device 2 collects probe information of the probe vehicle 1 every predetermined period (e.g., 1 second) or every predetermined distance, and accumulates the collected probe information in a memory thereof.

The communication device 3 such as a mobile phone or a smartphone is connected to the on-vehicle device 2. The probe information accumulated in the memory is wirelessly transmitted to the outside by the communication device 3. The probe information transmitted from the probe vehicle 1 is received by the base station 4 and relayed to the center apparatus 5. The on-vehicle device 2 itself may be a communication terminal such as a smartphone.

The probe vehicle 1 may transmit the probe information at any timing. Preferably, the probe information is transmitted periodically, for example, every 1 minute. When an occupant requests the center apparatus 5 to transmit traffic information, the communication device 3 may transmit the probe information accumulated in the memory of the on-vehicle device 2.

In this case, the occupant who desires to be provided with the traffic information operates the communication device 3 and transmits a service request signal to the center apparatus 5. At this time, the communication device 3 transmits the probe information, which has been accumulated in the memory at the time of transmission of the request signal, together with the request signal to the center apparatus 5.

### [Configuration of Center Apparatus]

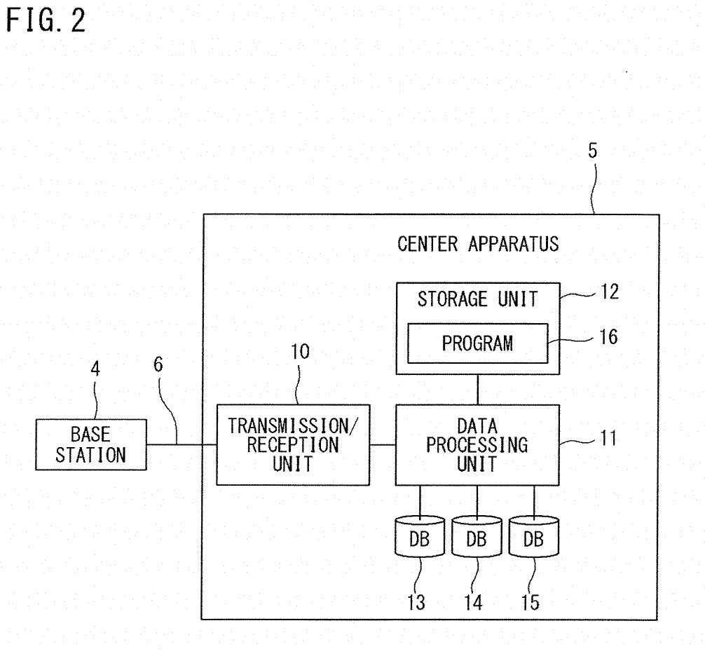

FIG. 2 is a block diagram showing a schematic configuration of the center apparatus 5.

As shown in FIG. 2, the center apparatus 5 includes a transmission/reception unit 10, a data processing unit 11, a storage unit 12, and various databases 13 to 15.

The transmission/reception unit 10 transmits/receives various types of data, such as probe information, a traffic congestion state, a link travel time, and an optimum route, to/from the base station 4 and the data processing unit 11.

The data processing unit 11 is implemented as a server computer that generates and distributes traffic information. The storage unit 12 is implemented as a recording medium such as a hard disk or a semiconductor memory, and stores therein a computer program 16 that causes the data processing unit 11 to function as a traffic information generation device.

The computer program 16 also includes software that causes the data processing unit 11 to execute a process of correcting a statistical speed of a vehicle at a predetermined target point to estimate an actual vehicle speed at the target point.

The computer program 16 can be transferred in a state of being recorded in a well-known recording medium such as a CD-ROM (Compact Disc Read Only Memory) or a DVD-ROM (Digital Video Disc Read Only Memory).

The computer program 16 may be transferred by data transmission (download) from a computer device such as a server computer.

In the probe database 13, probe information received from a probe vehicle 1 is stored. The probe information includes the vehicle ID, data generation time, vehicle position and vehicle speed at the data generation time, etc.

In the map database 14, map data of a digital road map is stored. The map data includes data of the positions of links and nodes and identification numbers thereof, which correspond to an actual road section that belongs to an area managed by the center apparatus 5.

In the speed database 15, a statistical speed of a probe vehicle 1 at each target point is stored. The statistical speed is calculated for each predetermined update cycle C by the data processing unit 11 on the basis of the probe information and the map data.

The data processing unit 11 determines, through map matching or the like, whether or not a probe vehicle 1 of a predetermined vehicle ID has passed a predetermined target point, and stores the statistical speed of the probe vehicle 1 having passed the target point, for each target point, in the speed database 15.

### [Content of Data in Speed Database]

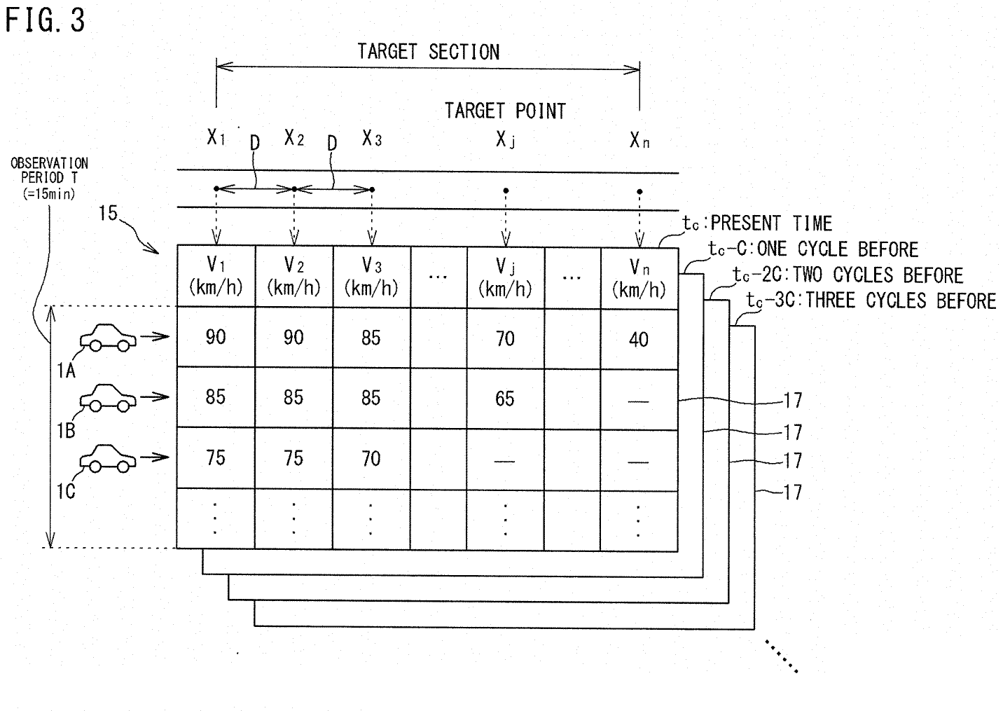

FIG. 3 is an explanatory diagram showing an example of a management table 17 of statistical speeds stored in the speed database 15.

In FIG. 3, tc denotes the present time, and C denotes an update cycle (e.g., 1 minute) of the management table 17. The data processing unit 11 updates the management table 17 for each update cycle C, while leaving a predetermined number (e.g., for 15 cycles) of past management tables 17 in the speed database 15.

Therefore, the speed database 15 contains not only the management table 17 at the present time tc but also a predetermined number of past management tables 17, such as a management table 17 at a time (tc-C) one cycle before the present time, a management table 17 at a time (tc-2C) two cycles before the present time, a management table 17 at a time (tc-3C) three cycles before the present time, etc., each having been calculated by the data processing unit 11 as statistical speeds at the present time tc for each update period C.

As shown in FIG. 3, in a target section in which statistical speeds should be obtained, target points Xj (j=1, 2, . . . , n) are defined so as to be scattered at predetermined intervals D (e.g., 50 m). In the management table 17, statistical speeds Vj of probe vehicles 1 at the respective target points Xj are stored.

A statistical speed Vj is a statistic of vehicle speeds of one or a plurality of probe vehicles 1 that have passed a target point Xj in a time period preceding the present time tc by a predetermined observation period T (e.g., 15 minutes). The statistic is, for example, an average, but may be another statistic such as a median.

For example, as for the target point X1, three probe vehicles 1A to 1C have passed the target point X1 at the vehicle speeds of 90, 85, and 75 (km/h), respectively, in an observation period T closest to the present time tc. Therefore, the statistical speed V1 at the target point X1 is V1=(90+85+75)/3=83.3 (km/h).

Likewise, the statistical speed V2 at the target point X2 is V2=(90+85+75)/3=83.3 (km/h), and the statistical speed V3 at the target point X3 is V3=(90+85+70)/3=81.7 (km/h).

As for the target point Xj, two probe vehicles 1A and 1B have passed the target point Xj at the vehicle speeds of 70 and 65 (km/h), respectively, in the observation period T closest to the present time tc. Therefore, the statistical speed Vj at the target point Xj is Vj=(70+65)/2=67.5 (km/h).

As for the target point Xn, one probe vehicle 1A has passed the target point Xn at a vehicle speed of 40 (km/h) in the observation period T closest to the present time tc. Therefore, the statistical speed Vn at the target point Xn is Vn=40 (km/h).

### [Vehicle Speed Generation Process]

In the center apparatus 5 of the present embodiment, the data processing unit 11 generates a vehicle speed at the present time at each target point Xj by using the statistical speed Vj at the target point Xj which is accumulated in the management table 17 of the speed database 15 and is updated for each update period C. This vehicle speed generation process is roughly divided into four processes, as follows. Hereinafter, the contents of the following four processes will be described in detail.

1) Speed transition section (present speed sequence) extracting process

2) Similar speed sequence searching process

3) Congestion propagation speed calculating process

4) Vehicle speed estimating process

### [Speed Transition Section Extracting Process]

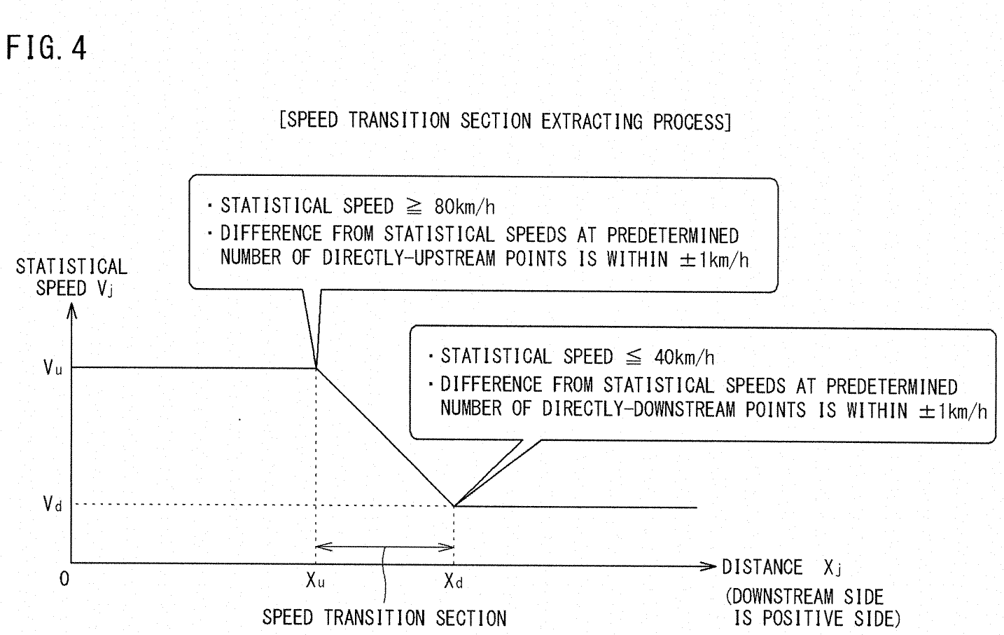

FIG. 4 is an explanatory diagram showing an example of the speed transition section extracting process.

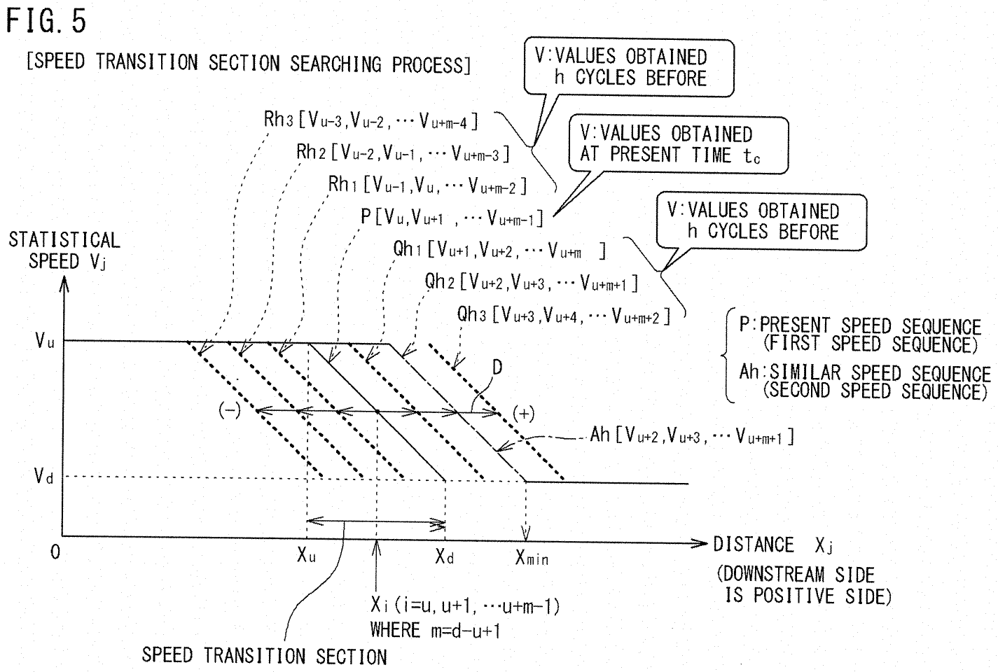

In FIG. 4, the distance Xj on the horizontal axis indicates coordinates of a distance with a start position (X1=0 m) of a target section being a point of origin, and the downstream side corresponds to the positive side. The statistical speed Vj on the vertical axis indicates a statistical speed at the point of the distance Xj. In FIG. 4, a graph representing the Xj-Vj relationship consists of a continuous straight line, but, in actuality, this is a discrete graph. The same applies to FIG. 5 to FIG. 8.

The “speed transition section” refers to a section in which the statistical speed Vj of a probe vehicle 1 transitions from a value not lower than a high-speed threshold to a value not higher than a low-speed threshold within a predetermined travel section length (e.g., 3000 m) in a road section consisting of an expressway, for example.

The data processing unit 11 extracts the aforementioned speed transition section on the basis of the statistical speeds Vj at the respective target points Xj included in the management table 17 at the present time tc (refer to FIG. 3). The specific content of this process is as follows.

The data processing unit 11 scans the target points Xj (j=1, 2, . . . , n) included in the target section from the upstream side toward the downstream side, and searches for a most upstream point Xd that satisfies the following conditions 1 and 2.

Condition 1: The statistical speed is not higher than the low-speed threshold (e.g., 40 (km/h)).

Condition 2: A difference between the statistical speed Vj at the target point Xj that satisfies the condition 1 and each of statistical speeds Vj+1 to Vj+5 at a predetermined number of (e.g., five) target points Xj+1 to Xj+5 existing directly downstream of the target point Xj, is within a predetermined speed range (e.g., ±1 (km/h)).

When the aforementioned point Xd has been found, the data processing unit 11 stores, in the memory, the detected point Xd as a “downstream end” of the speed transition section.

When the point Xd could not be found, the data processing unit 11 ends the process. That is, the vehicle speed estimating process is not executed in this cycle C.

The data processing unit 11 calculates an elapsed time Ts up to the present time tc from, for example, a passage time of a probe vehicle 1 that has most recently passed the point Xd among the probe vehicles 1 that have passed the point Xd during the observation period T.

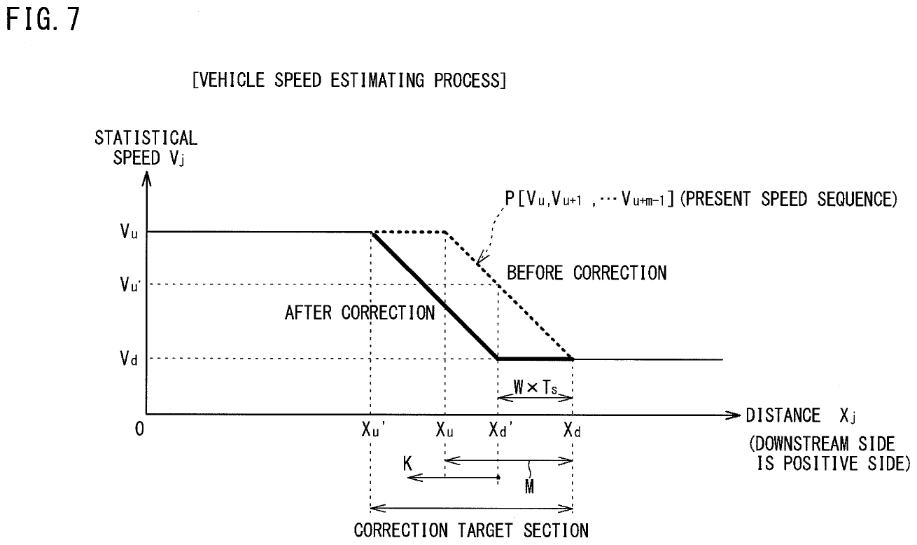

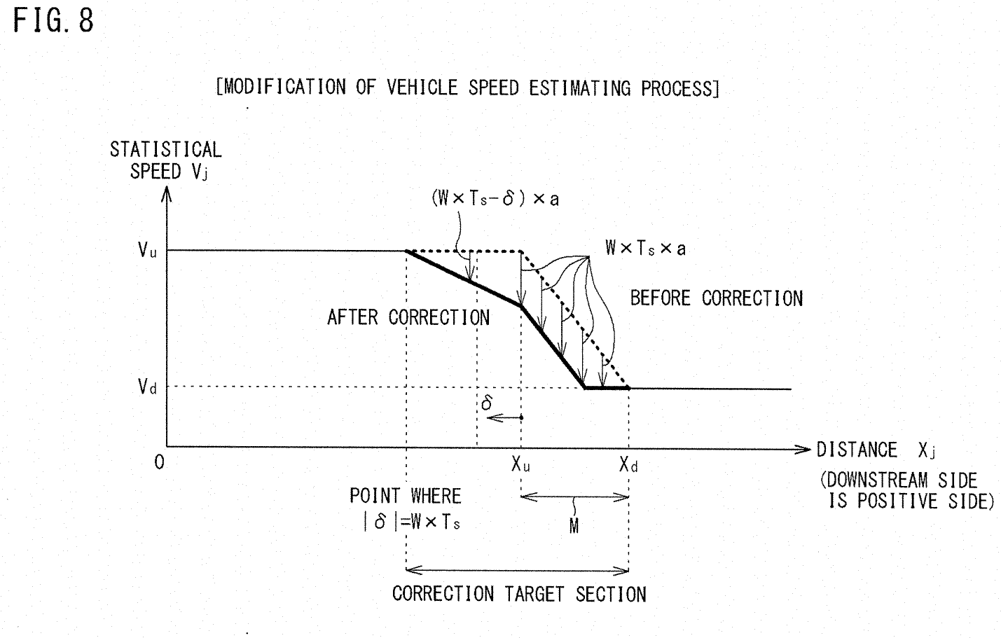

The start point of the elapsed time Ts may be a statistic (e.g., an average) of the passage times of the plurality of probe vehicles 1 that have passed the point Xd during the observation period T. The elapsed time Ts is used in the vehicle speed estimating process (FIG. 7 and FIG. 8) described below.

Next, the data processing unit 11 scans the target points Xj located on the upstream side of the point Xd, among the target points Xj (j=1, 2, . . . , n) included in the target section, and searches for a most downstream point Xu that satisfies the following conditions 3 and 4.

Condition 3: The statistical speed is not lower than the high speed (e.g., 80 (km/h)).

Condition 4: A difference between the statistical speed Vj at the target point Xj that satisfies the condition 3 and each of statistical speeds Vj-1 to Vj-5 at a predetermined number (e.g., five) of target points Xj-1 to Xj-5 existing directly upstream of the target point Xj, is within a predetermined speed range (e.g., ±1 (km/h)).

When the aforementioned point Xu has been found, the data processing unit 11 stores, in the memory, the detected point Xu as an “upstream end” of the speed transition section.

When the point Xu could not be found, the data processing unit 11 ends the process. That is, the vehicle speed estimating process is not executed in this cycle C.

Next, the data processing unit 11 calculates a distance from the point Xu to the point Xd, and determines whether or not the calculated distance is within the aforementioned travel section length (e.g., 3000 m).

When the determination result is positive, the data processing unit 11 stores, in the memory, a section from the point Xu to the point Xd, included in the target section as a “speed transition section”.

When the determination result is negative, the data processing unit 11 ends the process. That is, the vehicle speed estimating process is not executed in this cycle C.

### [Similar Speed Sequence Searching Process]

FIG. 5 is an explanatory diagram showing an example of a process of searching for a similar speed sequence A corresponding to a present speed sequence P.

The data processing unit 11 generates a present speed sequence P from statistical speeds in the extracted speed transition section. The present speed sequence P refers to a data sequence obtained by one-dimensionally arraying the values of statistical speeds Vi at target points Xi (i=u, u+1, u+m−1) included in the speed transition section.

Here, m denotes the number of data included in the present speed sequence P and m=d−u+1, u denotes the number of points up to the point Xu counted from a most upstream point (X1=0), and d denotes the number of points up to the point Xd counted from the most upstream point (X1=0).

Next, the data processing unit 11 generates a plurality of downstream-side speed sequences Qhk (k=1, 2, . . . ) on the basis of the statistical speeds Vj included in the management table 17 obtained h cycles before the present time.

Each downstream-side speed sequence Qhk is a data sequence of statistical speeds Vj, which has been obtained h cycles before the present time and includes the same number (m) of data as the present speed sequence P. Specifically, the downstream-side speed sequence Qhk is a data sequence including a statistical speed Vi+k at a target position Xi+k that is shifted by D×k from the present speed sequence P to the downstream side (positive side). Therefore, for example, downstream-side speed sequences Qh1 to Qh3 are the following data sequences, respectively.

Qh1 [Vu+1, Vu+2, Vu+m]

Qh2 [Vu+2, Vu+3, Vu+m+1]

Qh3 [Vu+3, Vu+4, Vu+m+2]

Further, the data processing unit 11 generates a plurality of upstream-side speed sequences Rhk (k=1, 2, . . . ) on the basis of the statistical speeds Vj included in the management table 17 obtained h cycles before the present time.

Each upstream-side speed sequence Rhk is a data sequence of statistical speeds Vj, which has been obtained h cycles before the present time and includes the same number (m) of data as the present speed sequence R Specifically, the upstream-side speed sequence Rhk is a data sequence including a statistical speed Vi−k at a target position Xi−k that is shifted by D×k from the present speed sequence P to the upstream side (negative side). Therefore, for example, upstream-side speed sequences Rh1 to Rh3 are the following data sequences, respectively.

Rh1 [Vu−1, Vu, Vu+m−2]

Rh2 [Vu−2, Vu−1, Vu+m−3]

Rh3 [Vu−3, Vu−2, Vu+m−4]

The maximum distance Dxkmax of shifting from the present speed sequence P to the downstream side and the upstream side may be set to about 1000 m (kmax≈20), for example.

The data processing unit 11 selects a speed sequence having the highest similarity in element change pattern from among the plurality of speed sequences Qhk, Rhk, and stores, in the memory, the selected speed sequence as a similar speed sequence Ah.

The similarity is an index indicating an approximation degree of a change pattern of elements (speed values) included in a data sequence. The similarity is defined as a reciprocal of the Euclidean distance or a reciprocal of the Manhattan distance. However, the data processing unit 11 does not necessarily select a speed sequence Qhk or Rhk having the highest similarity (smallest distance), and may select a speed sequence Qhk or Rhk having the second highest similarity.

FIG. 5 shows a case where a speed sequence Qh2, indicated by a virtual line, which is shifted by D×2 from the present speed sequence P to the downstream side, is the similar speed sequence Ah corresponding to the present speed sequence P.

When the search for the similar speed sequence Ah has been completed, the data processing unit 11 stores, in the memory, as Xmin, a target position Xu+m+1 corresponding to the lowest statistical speed Vu+m+1 among the statistical speeds (Vu+2, Vu+3, Vu+m+1) included in the similar speed sequence Ah.

On the condition that there are a plurality of speed sequences Qhk, Rhk having similarities not lower than a predetermined threshold, the data processing unit 11 selects the similar speed sequence Ah from among the plurality of speed sequences.

In other words, when there are no speed sequences Qhk, Rhk having similarities not lower than the predetermined threshold, the data processing unit 11 ends the process and does not execute the vehicle speed estimating process in this cycle C.

In the aforementioned searching process, when h is fixed to one value (e.g., h=5), the data processing unit 11 calculates one similar speed sequence A5 from speed sequences Q5k, R5k based on the statistical speeds Vj obtained five cycles before the present time.

In the aforementioned searching process, h may be changed among a plurality of values (e.g., h=1 to 4). In this case, the data processing unit 11 calculates four similar speed sequences Ah (h=1 to 4) from speed sequences Qhk, Rhk (h=1 to 4) based on the statistical speeds Vj obtained one to four cycles before the present time, respectively.

That is, the data processing unit 11 calculates a similar speed sequence A1 from speed sequences Q1k, R1k based on the statistical speeds Vj obtained one cycle before the present time, and calculates a similar speed sequence A2 from speed sequences Q2k, R2k based on the statistical speeds Vj obtained two cycles before the present time.

Further, the data processing unit 11 calculates a similar speed sequence A3 from speed sequences Q3k, R3k based on the statistical speeds Vj obtained three cycles before the present time, and calculates a similar speed sequence A4 from speed sequences Q4k, R4k based on the statistical speeds Vj obtained four cycles before the present time.

### [Congestion Propagation Speed Calculating Process]

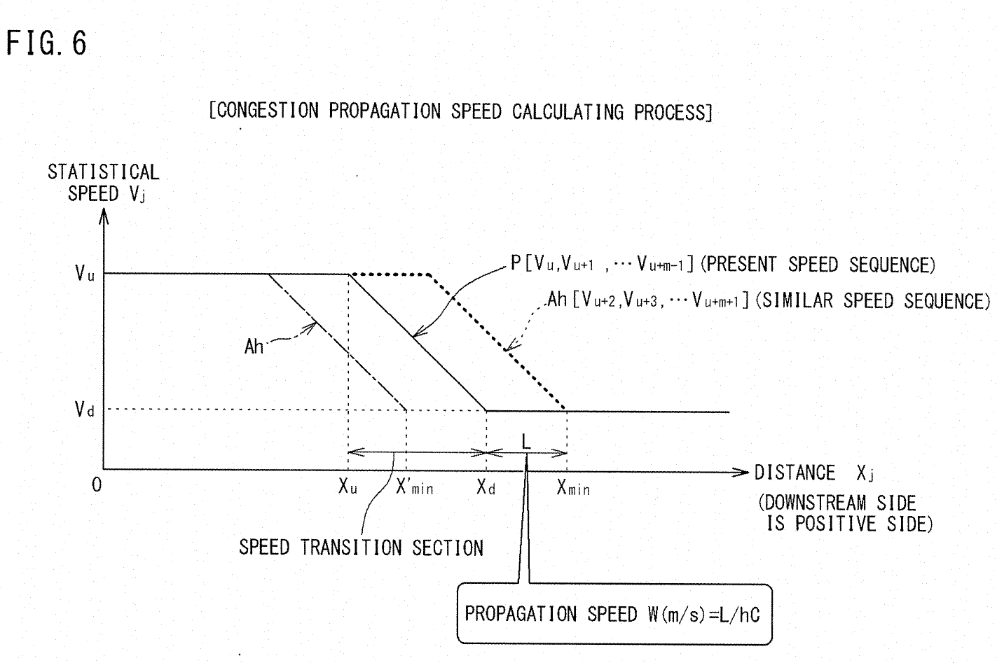

FIG. 6 is an explanatory diagram showing an example of the congestion propagation speed calculating process.

It is assumed that, in the searching process shown in FIG. 5, h is fixed to one value and only one similar speed sequence Ah is searched for. The statistical speeds (Vu+2, Vu+3, Vu+m+1) included in the similar speed sequence Ah are statistical speeds calculated at a time (tc-hC).

As shown by a broken line in FIG. 6, when the similar speed sequence Ah is positioned on the downstream side with respect to the present speed sequence P at the time tc, it is considered that, at the time (tc-hC) h cycles before the time tc, the present speed sequence P was present on the downstream side (positive side) by a distance L shown in FIG. 6.

Therefore, it can be estimated that traffic congestion, which caused the vehicle to decelerate from a speed Vu to a speed Vd, was present near the point Xmin at a time (tc-hC) and this traffic congestion has been extended by the distance L at the present time tc.

Meanwhile, as shown by a virtual line in FIG. 6, when the similar speed sequence Ah is positioned on the upstream side with respect to the present speed sequence P at the time tc, it is considered that, at the time (tc-hC) h cycles before the time tc, the present speed sequence P was present on the upstream side (negative side) by the distance L.

Therefore, it can be estimated that the traffic congestion, which caused the vehicle to decelerate from the speed Vu to the speed Vd was present near the point X′min at the time (tc-hC) and this traffic congestion has been diminished by the distance L at the present time tc.

Thus, the data processing unit 11 calculates the distance L between the point Xd and the point Xmin according to a calculation formula of L=Xmin−Xd. A sign (plus/minus) of the value of the distance L calculated according to the calculation formula represents a movement direction of the present speed sequence P with a lapse of time from the time (tc-hC) h cycles before the present time tc to the present time tc.

Further, the data processing unit 11 calculates a propagation speed W(m/s) of the traffic congestion according to a calculation formula of W=L/hC.

In this case, when the sign (plus/minus) of the value of the distance L (movement direction of the present speed sequence P) is plus, the data processing unit 11 determines that the traffic congestion is extending, and regards the propagation speed W as a propagation speed with respect to “extension of traffic congestion”.

Meanwhile, when the sign (plus/minus) of the value of the distance L (movement direction of the present speed sequence P) is minus, the data processing unit 11 determines that the traffic congestion is diminishing, and regards the propagation speed W as a propagation speed with respect to “diminishment of traffic congestion”.

In the searching process shown in FIG. 5, when a plurality of similar speed sequences Ah (h=1, 2, . . . ) have been calculated, the data processing unit 11 may adopt, as the propagation speed W, a statistic (e.g., an average) Wm of propagation speeds Wh obtained from the respective similar speed sequences Ah.

When four similar speed sequences A1 to A4 have been obtained, four propagation speeds W1 to W4 may be calculated from the respective similar speed sequences A1 to A4 according to the following formulae, and a propagation speed W to be used for the estimation process described below (FIG. 7 and FIG. 8) may be calculated according to W=(W1+W2+W3+W4)/4.

W1=L1/C

W2=L2/2C

W3=L3/3C

W4=L4/3C

Here, L1 is a distance from the point Xd to the point Xmin for A1, L2 is a distance from the point Xd to the point Xmin for A2, L3 is a distance from the point Xd to the point Xmin for A3, and L4 is a distance from the point Xd to the point Xmin for A4. [Vehicle speed estimating process]

FIG. 7 is an explanatory diagram showing an example of the vehicle speed estimating process.

The vehicle speed estimating process is a process of correcting a statistical speed Vj in a predetermined section including a speed transition section on the basis of a present speed sequence P and a propagation speed W to estimate an actual vehicle speed at a target point Xj included in the predetermined section.

In FIG. 7, a point Xd′ is a point on the upstream side from a point Xd by W×Ts, and a point Xu′ is a point on the upstream side from a point Xu by W×Ts.

W denotes a propagation speed calculated through the calculation process shown in FIG. 6. Ts denotes the aforementioned elapsed time. M denotes a distance from the point Xu to the point Xd (section length of the speed transition section). K denotes a distance in the negative direction with the point Xd′ being a base point.

The data processing unit 11 executes the following different processes depending on the sign (plus/minus) of the distance L to correct the statistical speed Vj in the predetermined section including the speed transition section. The predetermined section (correction target section) in which the statistical speed Vj is to be corrected has a section length of M+W×Ts.

(Case where Distance L is Plus (where Traffic Congestion is Extending))

1) Section from point Xd to point Xd′

The statistical speed Vj at the target point Xj is replaced with Vd.

2) Section from point Xd′ to Xu′

The statistical speed Vj at the target point Xj is replaced with (K×Vd+(M−K)×Vu')/M. These processes are equivalent to shifting the present speed sequence P to the upstream side by W×Ts.

(Case where Distance L is Minus (Case where Traffic Congestion is Diminishing))

1) Section from point Xu′ to point Xu

The statistical speed Vj at the target point Xj is replaced with Vu.

2) Section from point Xd′ to point Xu′

The statistical speed Vj at the target point Xj is replaced with (K×Vd+(M−K)×Vu′)/M. These processes are equivalent to shifting the present speed sequence P to the downstream side by W×Ts.

When estimation of the vehicle speed through the estimation process shown in FIG. 7 has been completed, the data processing unit 11 may determine the position of a traffic congestion tail included in the correction target section, on the basis of the estimated value of the vehicle speed at each point Xj included in the correction target section.

For example, in a case where a point at which the vehicle substantially starts deceleration due to traffic congestion is regarded as a traffic congestion tail, the data processing unit 11 may set the point Xu′ as the traffic congestion tail. Meanwhile, in a case where a point at which the vehicle substantially ends deceleration due to traffic congestion is regarded as a traffic congestion tail, the data processing unit 11 may set the point Xd′ as the traffic congestion tail. Alternatively, for example, an intermediate point between the above points may be regarded as a traffic congestion tail.

### [Modification of Vehicle Speed Estimating Process]

FIG. 8 is an explanatory diagram showing a modification of the vehicle speed estimating process.

In FIG. 8, a denotes an inclination (=(Vd−Vu)/(Xd−Xu)) of a present speed sequence P. Also, in the modification shown in FIG. 8, the data processing unit 11 executes the following different processes depending on the sign (plus/minus) of a distance L to correct a statistical speed Vj in a predetermined section including a speed transition section. The predetermined section in which the statistical speed Vj is to be corrected has a section length of M+W−Ts.

(Case where Distance L is Plus (where Traffic Congestion is Extending))

1) Section from point Xd to point Xu

The statistical speed Vj at the target point Xj is replaced with a correction speed Va calculated according to the following formula:

correction speed Va=Vj+|W|×Ts×a

2) Section on the upstream side from point Xu

While |W|×Ts−δ>0, where δ is a distance in the negative direction with the point Xu being a base point, is satisfied, the statistical speed Vj at the target point Xj is replaced with a correction speed Va calculated according to the following formula:

correction speed Va=Vj+(|W|×Ts−δ)×a

In both of the above cases 1) and 2), if Va<Vd, Va is made equal to Vd (Va=Vd).

(Case where Distance L is Minus (where Traffic Congestion is Diminishing))

1) Section from point Xd to point Xu

The statistical speed Vj at the target point Xj is replaced with a correction speed Va calculated according to the following formula:

correction speed Va=Vj+|W|×Ts×|a|

2) Section on the downstream side from point Xd

While |X|×Ts×δ>0, where δ is a distance in the positive direction with the point Xd being a base point, is satisfied, the statistical speed Vj at the target point Xj is replaced with a correction speed Va calculated based on the following formula:

correction speed Va=Vj+(|W|×Ts−δ)×|a|

In both of the above cases 1) and 2), if Va>Vu, Va is made equal to Vu (Va=Vu).

When estimation of the vehicle speed through the estimation process shown in FIG. 8 has been completed, the data processing unit 11 may determine the position of a traffic congestion tail included in the correction target section, on the basis of the estimated value of the vehicle speed at each point Xj included in the correction target section.

For example, in a case where a point at which the vehicle substantially starts deceleration due to congestion is regarded as a traffic congestion tail, the data processing unit 11 may set a point where Xj=δ, as the traffic congestion tail. Meanwhile, in a case where a point at which the vehicle substantially ends deceleration due to congestion is regarded as a traffic congestion tail, the data processing unit 11 may set a point where the vehicle speed is Vd, as the traffic congestion tail. Alternatively, for example, an intermediate point between the above points may be set as a traffic congestion tail.

### [Result of Simulation Test]

In order to confirm effectiveness of the estimation process according to the present embodiment (FIG. 4 to FIG. 8), a simulation test was performed for a predetermined road network by using a traffic flow simulator which is application software generally used for traffic simulation.

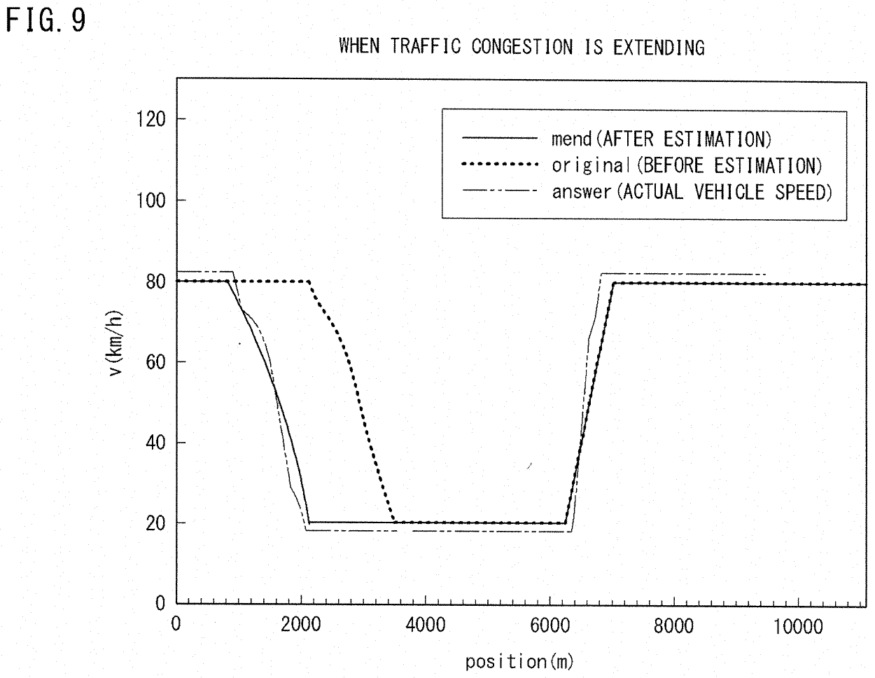

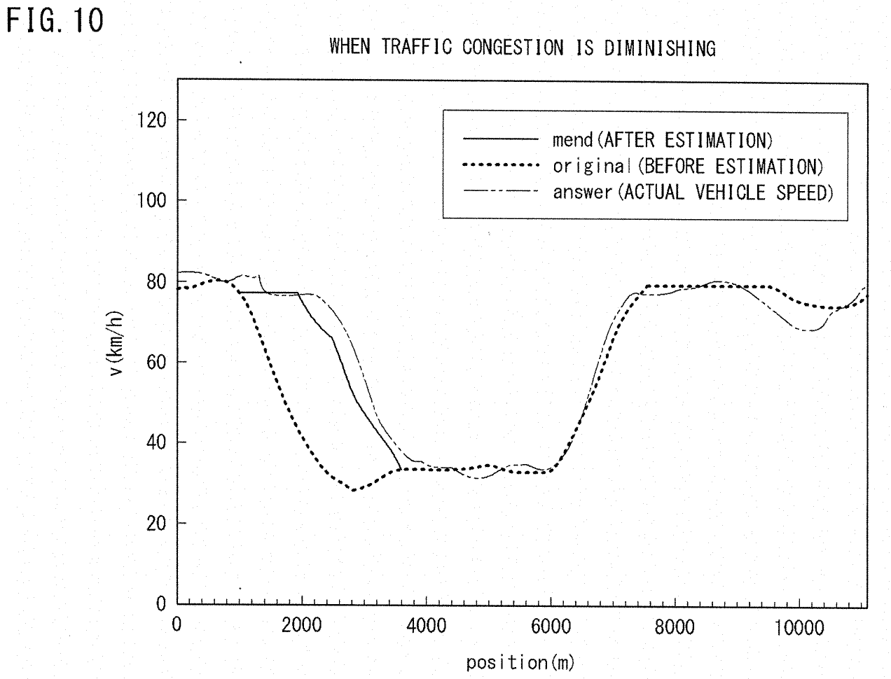

The result of the simulation test is shown in FIG. 9 and FIG. 10. FIG. 9 shows the simulation result in the case where traffic congestion is extending. FIG. 10 shows the simulation result in the case where traffic congestion is diminishing.

In each of FIG. 9 and FIG. 10, a graph of a virtual line (answer) is a graph of the actual vehicle speed of a probe vehicle 1. A graph of a broken line (original) is a graph of the statistical speed Vj before the estimation process. A graph of a solid line (mend) is a graph obtained when the estimation process of the present embodiment was performed.

As shown in FIG. 9, the statistical speed Vj (original) before the estimation process deviates about 1500 m from the actual vehicle speed (answer) to the positive side. However, the deviation is almost eliminated through the estimation process, and the vehicle speed (mend) after the estimation process substantially coincides with the actual vehicle speed (answer).

As shown in FIG. 10, the statistical speed Vj (original) before the estimation process deviates about 1500 m from the actual vehicle speed (answer) to the negative side. However, the deviation is almost eliminated through the estimation process, and the vehicle speed (mend) after the estimation process substantially coincides with the actual vehicle speed (answer).

As is obvious from these results, through execution of the estimation process according to the present embodiment, it is possible to estimate a vehicle speed approximate to the actual vehicle speed from the statistical speed Vj at each target section Xj, in both of the cases where traffic congestion is extending and where traffic congestion is diminishing.

### First Modification

In the aforementioned embodiment, the vehicle speed at the present time tc is estimated by performing correction to shift the present speed sequence P to the upstream side or the downstream side by the distance (=W×Ts) that is obtained by multiplying the propagation speed W of traffic congestion by the elapsed time Ts from the Xd passage time of the probe vehicle 1 within the observation period T, to the present time tc (refer to FIG. 7).

However, when it is supposed that the same congestion speed W will be maintained after the present time tc, the elapsed time by which the propagation speed W is multiplied may be estimated to be a little longer, whereby a vehicle speed at a future time can be estimated.

For example, in a case of estimating a vehicle speed at a future time after lapse of ΔT (e.g., 2 minutes) from the present time tc, the shift amount of the present speed sequence P may be changed to W×(Ts+ΔT).

Meanwhile, when it is supposed that the same congestion speed W will not be maintained after a time by ΔT prior to the present time tc, the elapsed time by which the propagation speed W is multiplied may be estimated to be a little shorter, whereby a vehicle speed at a time (tc-ΔT) in the past from the present time tc can be estimated.

### Second Modification

In the above embodiment, the speed sequence used for the speed transition section extracting process is defined as a “first speed sequence” while the speed sequence that is similar to the first speed sequence in variation pattern of elements is defined as a “second speed sequence”. In this case, in order to obtain a propagation speed of traffic congestion, the statistical speed in the second speed sequence needs to be a statistic older than the statistical speed in the first speed sequence, but the statistical speed in the first speed sequence is not necessarily the latest statistic (the statistical speed recorded in the latest management table 17).

That is, in the above embodiment, the first speed sequence consists of the present speed sequence P generated based on the statistical speed Vj in the management table 17 at the present time tc. However, the first speed sequence may be a speed sequence generated not from the latest management table 17 but from the statistical speed Vj in slightly older management table 17 (e.g., the management table 17 at a time (tc-C) one cycle before the present time).

### Other Modifications

The embodiment disclosed herein is illustrative in all aspects and should be considered not restrictive. The scope of the present invention is not limited by the configuration of the above-described embodiment but is defined by the claims, and is intended to include meaning equivalent to the scope of the claims and all modifications within the scope.

For example, in the above embodiment, a case is assumed where a statistical speed Vj at a target point Xj is calculated from probe information. However, the statistical speed Vj at the target point Xj may be calculated from a signal detected by a vehicle detector or image data detected by an image type vehicle detector.

### REFERENCE SIGNS LIST

1 probe vehicle

2 on-vehicle device

3 communication device

4 base station

5 center apparatus (complementation apparatus)

6 communication line

10 transmission/reception unit

11 data processing unit

12 storage unit

13 probe database

14 map database

15 speed database

16 computer program

17 management table

20 traffic information processing system

1. A non-transitory computer readable storage medium storing a computer program for causing a computer to function as a vehicle speed estimating device, the program causing the computer to function as a data processing unit executing:
an extraction process of extracting a speed transition section which includes a plurality of target points and in which a statistical speed gradually decreases from a speed not lower than a high-speed threshold to a speed not higher than a low-speed threshold;
a calculation process of calculating a propagation speed of traffic congestion on the basis of a first speed sequence having, as elements, statistical speeds at the plurality of target points included in the speed transition section; and
an estimation process of estimating a vehicle speed in a predetermined section including the speed transition section, on the basis of the propagation speed.

2. The storage medium according to claim 1, wherein
the data processing unit
executes a searching process of searching for a second speed sequence that is similar to the first speed sequence in variation pattern of the elements, the second speed sequence having, as elements, statistical speeds older than the statistical speeds of the first speed sequence, and
calculates the propagation speed on the basis of a distance and a time difference between the first speed sequence and the second speed sequence.

3. The storage medium according to claim 2, wherein
the data processing unit searches for a plurality of second speed sequences that are different in oldness, calculates a plurality of propagation speeds by using the plurality of second speed sequences, and uses, for the estimation process, a statistic of the plurality of calculated propagation speeds.

4. The storage medium according to any claim 1, wherein
the data processing unit
calculates the statistical speeds on the basis of probe information of one or a plurality of probe vehicles, and
corrects the statistical speeds at the target points included in the predetermined section, on the basis of the propagation speed and an elapsed time from a time point when the probe vehicle has passed a predetermined target point in the speed transition section, thereby estimating the vehicle speed at the target point.

5. The storage medium according to any claim 1, wherein
the data processing unit determines a position of a traffic congestion tail in the predetermined section, on the basis of the vehicle speed in the predetermined section.

6. A device for estimating a vehicle speed, comprising:
a speed database in which statistical speeds at a plurality of target points are stored; and
a data processing unit configured to estimate the vehicle speed by using the stored statistical speeds, wherein
the data processing unit executes
an extraction process of extracting a speed transition section which includes a plurality of target points and in which a statistical speed gradually decreases from a speed not lower than a high-speed threshold to a speed not higher than a low-speed threshold,
a calculation process of calculating a propagation speed of traffic congestion on the basis of a first speed sequence having, as elements, statistical speeds at the plurality of target points included in the speed transition section, and
an estimation process of estimating a vehicle speed in a predetermined section including the speed transition section, on the basis of the propagation speed.

7. A method for estimating a vehicle speed, comprising the steps of:
extracting a speed transition section which includes a plurality of target points and in which a statistical speed gradually decreases from a speed not lower than a high-speed threshold to a speed not higher than a low-speed threshold;
calculating a propagation speed of traffic congestion on the basis of a first speed sequence having, as elements, statistical speeds at the plurality of target points included in the speed transition section; and
estimating a vehicle speed in a predetermined section including the speed transition section, on the basis of the propagation speed.

8. A non-transitory computer readable storage medium storing a computer program for causing a computer to function as a traffic congestion tendency estimating device, the program causing the computer to function as a data processing unit executing:
an extraction process of extracting a speed transition section which includes a plurality of target points and in which a statistical speed gradually decreases from a speed not lower than a high-speed threshold to a speed not higher than a low-speed threshold;
a calculation process of calculating a movement direction, with a lapse of time, of a first speed sequence having, as elements, statistical speeds at the plurality of target points included in the speed transition section; and
an estimation process of estimating, based on the movement direction, whether traffic congestion tends to extend or tends to diminish in a predetermined section including the speed transition section.

9. A device for estimating traffic congestion tendency, comprising:
a speed database in which statistical speeds at a plurality of target points are stored; and
a data processing unit configured to estimate the traffic congestion tendency by using the stored statistical speeds, wherein
the data processing unit executes
an extraction process of extracting a speed transition section which includes a plurality of target points and in which a statistical speed gradually decreases from a speed not lower than a high-speed threshold to a speed not higher than a low-speed threshold,
a calculation process of calculating a movement direction, with a lapse of time, of a first speed sequence having, as elements, statistical speeds at the plurality of target points included in the speed transition section, and
an estimation process of estimating, based on the movement direction, whether traffic congestion tends to extend or tends to diminish in a predetermined section including the speed transition section.

10. A method for estimating traffic congestion tendency, comprising the steps of:
extracting a speed transition section which includes a plurality of target points and in which a statistical speed gradually decreases from a speed not lower than a high-speed threshold to a speed not higher than a low-speed threshold;
calculating a movement direction, with a lapse of time, of a first speed sequence having, as elements, statistical speeds at the plurality of target points included in the speed transition section; and
estimating, based on the movement direction, whether traffic congestion tends to extend or tends to diminish in a predetermined section including the speed transition section.
